(19) United States
(12) Patent Application Publication
(10) Pub. No.: US 2015/0293645 A1
(43) Pub. Date: Oct. 15, 2015

(54) HOLOGRAPHIC COLLECTION AND EMISSION TURNING FILM SYSTEM

(71) Applicant: Qualcomm Incorporated, San Diego, CA (US)

(72) Inventors: Ying Zhou, Milpitas, CA (US); Russell Wayne Gruhlke, Milpitas, CA (US)

(73) Assignee: Qualcomm Incorporated, San Diego, CA (US)

(21) Appl. No.: 14/251,450

(22) Filed: Apr. 11, 2014

(51) Int. Cl. G06F 3/042; G06F 3/0488

(52) U.S. Cl. CPC G06F 3/0428; G06F 3/04883; G06F 2203/04109; G06F 2203/04808

(57) ABSTRACT

Various examples of diffraction grating layers for touch/proximity sensing apparatus are provided. The touch/proximity sensing apparatus may include a light guide and light sources edge-coupled to first side of the light guide. Light sensors may be edge-coupled to a second side of the light guide. The apparatus may include light sensors edge-coupled to the first side of the light guide and/or light sources edge-coupled to the second side of the light guide. A single diffraction grating layer proximate the light guide may be capable of extracting light from the light guide and of directing incident light into the light guide and towards the light sensors. In some examples, a single area or volume of the diffraction grating layer may include a diffraction grating capable of extracting light from the light guide and a diffraction grating capable of directing incident light into the light guide and towards a light sensor.

### TECHNICAL FIELD

This disclosure relates generally to touch sensor systems and gesture-detection systems.

### DESCRIPTION OF THE RELATED TECHNOLOGY

The basic function of a touch sensing device is to convert the detected presence of a finger, stylus or pen near or on a touch screen into position information. Such position information can be used as input for further action on a mobile phone, a computer, or another such device. Various types of touch sensing devices are currently in use. Some are based on detected changes in resistivity or capacitance, on acoustical responses, etc. At present, the most widely used touch sensing techniques are projected capacitance methods, wherein the presence of a conductive body (such as a finger, a conductive stylus, etc.) on or near the cover glass of a display is sensed as a change in the local capacitance between a pair of wires. In some implementations, the pair of wires may be on the inside surface of a substantially transparent cover substrate (a “cover glass”) or a substantially transparent display substrate (a “display glass”). Although existing touch sensing devices are generally satisfactory, improved devises and methods that allow proximity sensing would be desirable.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus that includes a light guide; a light source system including a first plurality of light sources capable of coupling light into a first side of the light guide; a light sensor system including a plurality of light sensors edge-coupled to at least a second side of the light guide; and a diffraction grating layer proximate the light guide. In some implementations, the diffraction grating layer may include a first plurality of diffraction grating elements capable of extracting light from the light guide and directing extracted light out of the light guide. The diffraction grating layer may include a second plurality of diffraction grating elements capable of directing incident light into the light guide and towards the plurality of light sensors. In some examples, the light source system may include at least one vertical-cavity surface-emitting laser (VCSEL).

In some implementations, an instance of the first plurality of diffraction grating elements and an instance of the second plurality of diffraction grating elements are both within a single area or volume of the diffraction grating layer. The diffraction grating layer may, for example, be (or may include) a holographic film layer.

In some examples, at least some instances of the first plurality of diffraction grating elements may be capable of selectively directing extracted light within a wavelength range and within a first angle range relative to a plane of the light guide. The second plurality of diffraction grating elements may be capable of selectively directing light that is incident within a wavelength range and within an angle range, relative to a plane of the light guide, towards the plurality of light sensors.

In some implementations, at least some light sensors of the light sensor system may be disposed on the first side of the light guide. At least some instances of the first plurality of diffraction grating elements may be capable of directing light towards a corresponding light sensor disposed on the first side of the light guide.

In some examples, instances of the first plurality of diffraction grating elements may be capable of diffracting incident light in a first direction within the light guide and instances of the second plurality of diffraction grating elements may be capable of diffracting incident light in a second direction within the light guide. The first direction may, in some instances, be substantially orthogonal to the second direction.

According to some implementations, the light source system may be capable of providing modulated light of a wavelength range into the light guide. The apparatus may include a filter capable of passing the modulated incident light of the wavelength range to the light sensors.

At least some of the incident light may be reflected or scattered from an object. Some implementations also include a control system that may be capable of: controlling the light source system to provide light to at least the first side of the light guide; receiving light sensor data from the light sensor system, the light sensor data corresponding to incident light received by light sensors; and determining a location of the object based, at least in part, on the light sensor data.

In some examples, at least some light sensors of the light sensor system may be edge-coupled to the first side of the light guide. The light source system may include a second plurality of light sources disposed on, and capable of coupling light into, the second side of the light guide. At least some of the incident light may be reflected or scattered from an object. Some implementations also include a control system that may be capable of: causing the first plurality of light sources or the second plurality of light sources to provide light at substantially the same time; receiving light sensor data from the light sensor system, the light sensor data corresponding to incident light received by light sensors; and determining a location of the object based, at least in part, on the light sensor data.

Some aspects of this disclosure may be implemented, at least in part, according to a non-transitory medium having software stored thereon. The non-transitory medium may, for example, include a random access memory (RAM), a read-only memory (ROM), optical disk storage, magnetic disk storage, flash memory, etc. The software may include instructions for controlling at least one device to couple light of a wavelength range from first light sources of a light source system into a first side of a light guide. The light guide may include a first plurality of diffraction grating elements capable of extracting light of the wavelength range from the light guide. The light guide may be capable of receiving incident light, including extracted light that is scattered or reflected from an object proximate the light guide, and directing, via a second plurality of diffraction grating elements, a portion of the incident light that is within the wavelength range into the light guide and towards light sensors of a light sensor system. The software may include instructions for determining a location of the object based, at least in part, on light sensor data corresponding to the portion of the incident light. The determination may, for example, be made by a control system according to the instructions.

In some examples, the directing may involve directing incident light towards light sensors disposed on the first side of the light guide. The software may include instructions for controlling the first light sources to provide light at substantially the same time. Alternatively, or additionally, the software may include instructions for controlling second light sources to provide light to the second side of the light guide at substantially the same time.

Another innovative aspect of the subject matter described in this disclosure can be implemented in a method that may involve: coupling light of a wavelength range from first light sources of a light source system into a first side of a light guide and extracting light of the wavelength range from the light guide via a first plurality of diffraction grating elements. The method may involve receiving incident light, including extracted light that is scattered or reflected from an object proximate the light guide. The method may involve directing, via a second plurality of diffraction grating elements, a portion of the incident light that is within the wavelength range into the light guide and towards light sensors of a light sensor system. The method may involve determining a location of the object based, at least in part, on light sensor data corresponding to the portion of the incident light.

In some implementations, the directing may involve directing incident light towards light sensors disposed on a second side of the light guide. In some examples, the directing may involve directing incident light towards light sensors disposed on the first side of the light guide.

In some implementations, the method may involve controlling the first light sources to provide light at substantially the same time. Alternatively, or additionally, the method may involve controlling second light sources to provide light to the second side of the light guide at substantially the same time.

In some examples, the extracting and the directing may be performed, at least in part, by an instance of the first plurality of diffraction grating elements and an instance of the second plurality of diffraction grating elements, both instances being in a single area or volume of a diffraction grating layer. In some implementations, the coupling may involve coupling modulated light of the wavelength range into the first side of the light guide, further comprising filtering the incident light to pass modulated light within the wavelength range to the light sensors.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a block diagram that shows examples of elements of a touch/proximity sensing apparatus.

FIG. 2 is top view that shows examples of elements of a touch/proximity sensing apparatus.

FIG. 3 is a perspective diagram that shows an example of a touch/proximity sensing apparatus.

FIG. 4 illustrates another example of a touch/proximity sensing apparatus.

FIG. 5 illustrates an alternative example of a touch/proximity sensing apparatus.

FIG. 6 illustrates another example of a touch/proximity sensing apparatus.

FIG. 7 illustrates another alternative example of a touch/proximity sensing apparatus.

FIG. 8 illustrates a cross-sectional view through a portion of an example of a touch/proximity sensing apparatus.

FIG. 9A illustrates an alternative example of a touch/proximity sensing apparatus.

FIG. 9B illustrates an example of a diffraction grating layer that provides an alternative arrangement of diffraction grating elements.

FIG. 10 illustrates another example of a touch/proximity sensing apparatus.

FIG. 11A is a block diagram that shows examples of elements of a touch/proximity sensing apparatus.

FIG. 11B is a block diagram that shows example components of a light source system.

FIG. 11C is a block diagram that shows example components of a light sensor system.

FIG. 12 is a flow diagram that outlines blocks of a method of controlling a touch/proximity sensing apparatus.

FIGS. 13A and 13B show examples of system block diagrams illustrating a display device that includes a touch/proximity sensing apparatus as described herein.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

In some implementations, a touch/proximity sensing apparatus may include a light guide and light sources edge-coupled to at least a first side of the light guide. Light sensors may be edge-coupled to at least a second side of the light guide. In some implementations, the apparatus may include light sensors edge-coupled to the first side of the light guide and/or light sources edge-coupled to the second side of the light guide. The apparatus may include a diffraction grating layer proximate the light guide. In some examples, a single diffraction grating layer may be capable of extracting light from the light guide and of directing incident light into the light guide and towards the light sensors. In some implementations, a single area or volume of the diffraction grating layer may include an instance of a light-extracting diffraction grating capable of extracting light from the light guide and an instance of a light-collecting diffraction grating capable of directing incident light into the light guide and towards one of the light sensors.

Particular implementations of the subject matter described in this disclosure can be implemented to realize one or more of the following potential advantages. By combining light-extracting and light-collecting functionality in a single layer, a thinner touch/proximity sensing apparatus may be provided. Some implementations, including those in which a single area or volume of the diffraction grating layer includes a light-extracting diffraction grating and a light-collecting diffraction grating, allow more than one coordinate (for example, the “x” and “y” coordinates) of a detected object to be determined at substantially the same time. In some such implementations, light sources along one side of the light guide may be illuminated at the same time, or substantially the same time, instead of being illuminated in a sequential manner. Such implementations may provide faster response time for detection, as well as a simplified control procedure.

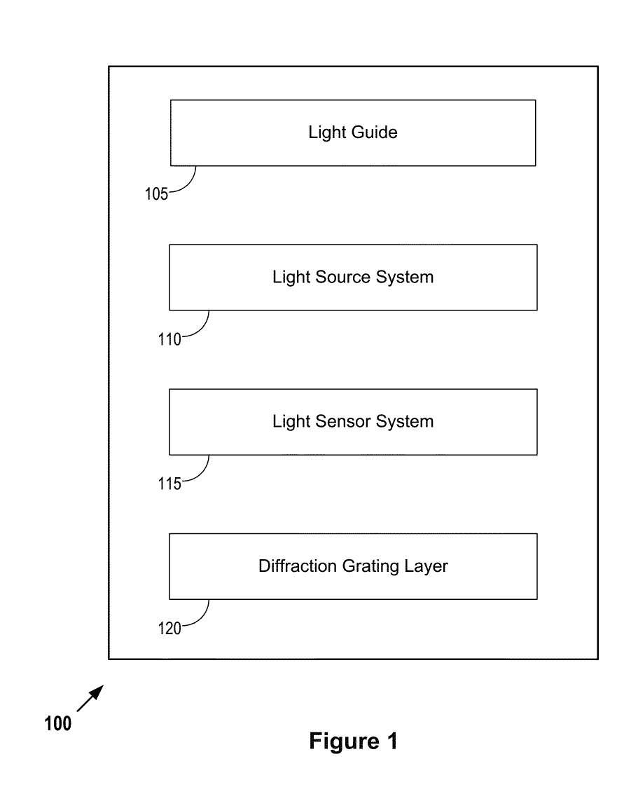

FIG. 1 is a block diagram that shows examples of elements of a touch/proximity sensing apparatus. In this example, the touch/proximity sensing apparatus 100 includes a light guide 105, a light source system 110, a light sensor system 115 and a diffraction grating layer 120. The light source system 110 may include light sources capable of coupling light into at least a first side of the light guide 105. The light sources may be edge-coupled to at least the first side of the light guide 105. The light sensor system 115 may include light sensors disposed along (e.g., edge-coupled to) at least a second side of the light guide 105.

The diffraction grating layer 120 may be disposed proximate the light guide 105. In some implementations, the diffraction grating layer 120 may be a holographic film layer. The diffraction grating layer 120 may include first diffraction grating elements capable of extracting light from the light guide 105 and directing extracted light out of the light guide 105. The diffraction grating layer 120 may include second diffraction grating elements capable of directing incident light into the light guide 105 and towards light sensors of the light sensor system 115. At least some of the incident light may be reflected and/or scattered from an object proximate the light guide 105.

The first diffraction grating elements may sometimes be referred to herein as “light-extracting” diffraction grating elements and the second diffraction grating elements may sometimes be referred to herein as “light-collecting” diffraction grating elements. However, it will be appreciated that because of the property of reciprocity, light can propagate along the same path in opposite directions. Accordingly, the same diffraction grating element may function as a light-extracting diffraction grating element and as a light-collecting diffraction grating element.

At least some instances of the first plurality of diffraction grating elements may be capable of selectively directing extracted light within a wavelength range and within a first angle range relative to a plane of the light guide. Similarly, at least some instances of the second plurality of diffraction grating elements may be capable of selectively directing light that is incident within a wavelength range and within an angle range, relative to a plane of the light guide, towards the plurality of light sensors.

The wavelength range may correspond to a wavelength range of light provided by the light source system. In some implementations, the wavelength range may be outside of the visible range, in order to avoid creating artifacts that could be visible to a user. Such visible artifacts could, for example, interfere with a user's viewing of images provided on an underlying display. Accordingly, in some implementations the wavelength range may be in the infrared range.

In some implementations, an instance of the first plurality of diffraction grating elements and an instance of the second plurality of diffraction grating elements may both be within a single area or volume of the diffraction grating layer 120. For example, an instance of the first plurality of diffraction grating elements and an instance of the second plurality of diffraction grating elements may both be within a single area or volume of a holographic film layer. Various examples are described below.

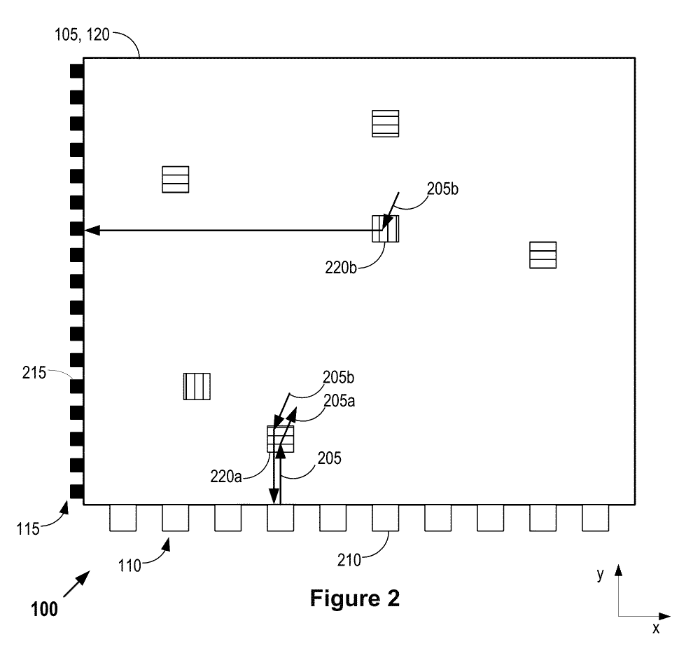

FIG. 2 is top view that shows examples of elements of a touch/proximity sensing apparatus. FIG. 2, like other drawings provided herein, is not necessarily drawn to scale. Moreover, the numbers, types and arrangements of elements are merely made by way of example. In FIG. 2, for example, only a few instances of diffraction grating elements are shown, whereas an actual touch/proximity sensing apparatus 100 would generally have many more such elements.

In the implementation shown in FIG. 2, the touch/proximity sensing apparatus 100 includes a light source system 110. The light source system 110 includes light sources 210 disposed along, and capable of providing light 205 to, a first side of the light guide 105. In this example, the light sources 210 are edge-coupled to the first side of the light guide 105. The light sources 210 may be capable of providing collimated light, or a partially collimated light along only one direction (for example, only in direction parallel to the light guide surface), to the light guide 105. In some implementations, the light sources 210 may include laser diodes or vertical-cavity surface-emitting lasers (VCSELs). The light sources 210 may be capable of providing light in a predetermined wavelength range, which may be outside of the visible spectrum. The light source system 110 may be capable of modulating the amplitude of light and pulse widths at a certain frequency provided by the light sources 210.

In this example, the touch/proximity sensing apparatus 100 has a light sensor system 115 that includes a plurality of light sensors 215 disposed along (e.g., edge-coupled to) at least a second side of the light guide 105. The light sensors 215 may, for example, be photodiodes, such as silicon photodiodes. In some examples, the light sensors 215 may include a charge-coupled device (CCD) array or a complementary metal-oxide-semiconductor (CMOS) array. In some implementations, the light sensor system 115 (and/or another element of the touch/proximity sensing apparatus 100) may be capable of filtering out other wavelengths of light that are outside of the wavelength range provided by the light source system 110. The light sensor system 115, and/or another element of the touch/proximity sensing apparatus 100 (e.g., an element of a control system) may be capable of passing the incident light in the same modulation and the wavelength range provided by the light source system 110, to the light sensors 215.

Although 10 instances of the light sources 210 and 17 instances of the light sensors 215 are shown in FIG. 2, alternative implementations may have more or fewer of these elements. In some implementations, the width and the spacing of the light sources 210 and/or the light sensors 215 may be on the order of a few millimeters. For example, in some implementations each of the light sources 210 and/or the light sensors 215 may have a width in the range of, e.g., 0.5-5 millimeters. In some implementations, the light sources 210 and/or the light sensors 215 may be spaced between 3 and 10 millimeters apart, e.g., approximately 5 millimeters apart. However, in alternative implementations, the light sources 210 and light sensors 215 may have other sizes and/or spacings.

In the example shown in FIG. 2, diffraction grating elements 220a are capable of extracting light 205 from the light guide 105 and directing extracted light 205a out of the light guide 105. The diffraction grating elements 220a may be capable of selectively directing extracted light 205a within a wavelength range and within a first angle range relative to a plane of the light guide 105.

For example, the diffraction grating elements 220a may be capable of selectively directing extracted light 205a of a predetermined wavelength range within an angle range of a few degrees (e.g., less than 5 degrees, less than 10 degrees, less than 15 degrees, etc.) relative to a normal to the plane of the light guide 105. The wavelength range may be in the infrared range. In some implementations, the wavelength range may be within a few nanometers (e.g., less than 5 nanometers, less than 10 nanometers, less than 15 nanometers, etc.) relative to a target wavelength. In some implementations, the target wavelength may be 850 nanometers.

In the example shown in FIG. 2, diffraction grating elements 220b are capable of directing incident light 205b into the light guide 105 and towards the plurality of light sensors 215. The incident light 205b may, for example, be scattered by and/or reflected from an object on or near the light guide 215. In some implementations, each of the diffraction grating elements 220b may be capable of directing light to an individual light sensor 215. The diffraction grating elements 220b may be capable of selectively directing incident light 205b that is within a wavelength range and within an angle range, relative to a plane of the light guide, towards the plurality of light sensors. The wavelength range may be the same, or substantially the same, as the wavelength range of light extracted from the light guide 105 by the diffraction grating elements 220a. This wavelength selectivity may help the touch/proximity sensing apparatus 100 distinguish signal from ambient light noise.

In the example shown in FIG. 2, when one or more light sensors 215 receive incident light 205b of the predetermined wavelength range that has been scattered and/or reflected by an object, the touch/proximity sensing apparatus 100 may determine one or more “y” coordinates of the object corresponding to the “y” coordinate(s) of the light sensor(s) 215. By controlling the light sources 210 to provide light to the light guide 105 in a predetermined pattern (e.g., sequentially), the touch/proximity sensing apparatus 100 may determine one or more “x” coordinates of the object corresponding to the “x” coordinate(s) of the light source(s) 210 that are providing light at a particular time. Accordingly, “x” and “y” coordinates of the object may be determined.

According to some such implementations, the touch/proximity sensing apparatus 100 may include a control system capable of controlling the light source system 110 to provide light 205 to at least the first side of the light guide 105, e.g., in a sequential manner, or in a specific pattern. The control system may be capable of receiving light sensor data from the light sensor system 115. The light sensor data may correspond to incident light 205b received by light sensors 215. At least some of the incident light may be reflected or scattered from an object. The control system may be capable of determining a location of the object based, at least in part, on the light sensor data.

In this implementation, the primary purposes of the diffraction grating elements 220a are extracting light 205 from the light guide 105 and directing extracted light 205a out of the light guide 105. Accordingly, the diffraction grating elements 220a may be considered “light-extracting” diffraction grating elements. However, it will be appreciated that because of the property of reciprocity, light can propagate along the same path in opposite directions. Accordingly, the same diffraction grating element 220a may function as a light-extracting diffraction grating element and as a light-collecting diffraction grating element. However, in the example shown in FIG. 2, the incident light 205b light collected by the diffraction grating elements 220a is directed towards a side of the light guide 105 that includes light sources 210 but not light sensors 215.

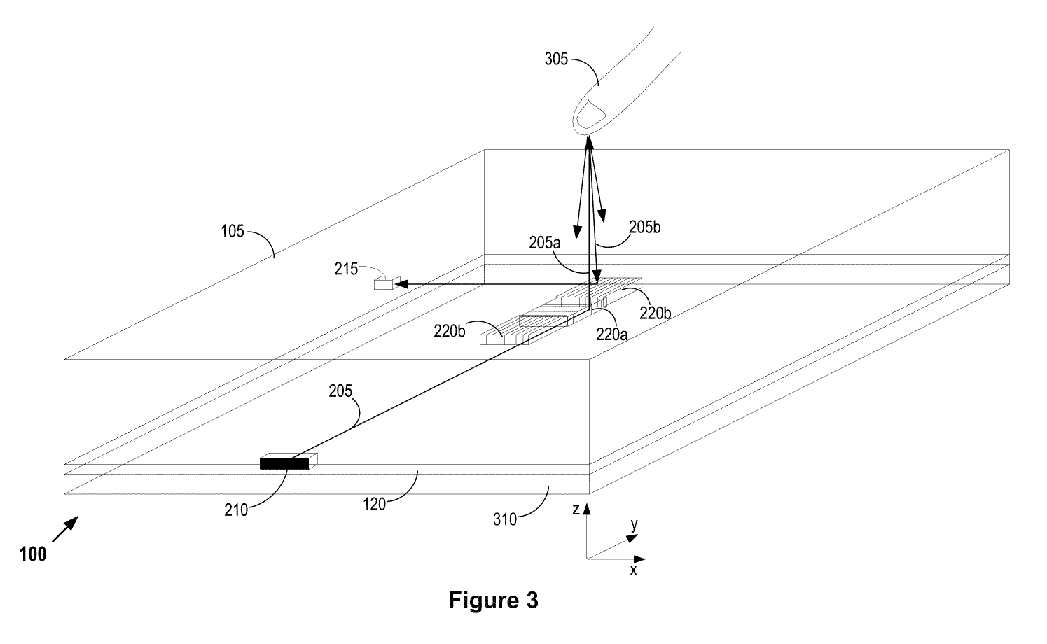

FIG. 3 is a perspective diagram that shows an example of a touch/proximity sensing apparatus. In this example, the touch/proximity sensing apparatus 100 includes a light guide 105, a diffraction grating layer 120 disposed on the light guide 105, and a support film 310. Diffraction grating elements 220a and diffraction grating elements 220b are formed in the diffraction grating layer 120. For the sake of simplicity, a single light source 210, a single light sensor 215, one diffraction grating element 220a and two diffraction grating elements 220b are illustrated in FIG. 3. However, an actual touch/proximity sensing apparatus 100 would generally include multiple instances of all of these elements. As with other figures provided herein, FIG. 3 is not drawn to scale. In particular, the thickness of the light guide 105 and other layers have been exaggerated as compared to the size of the object 305.

The light guide 105 may include one or more layers of transparent or substantially transparent material, such as glass, polymer, etc. In some implementations, the light guide 105 may include a core layer and one or more cladding layers having relatively lower indices of refraction. However, in some implementations the light guide 105 may be intended to form an outer layer of a touch/proximity sensing apparatus. The lower index of refraction of air may provide the necessary difference in refractive index on the upper surface of the light guide 105. In some implementations, the diffraction grating layer 120 and/or the support film 310 may have a lower index of refraction than the light guide 105, whereas in other implementations the diffraction grating layer 120 and/or the support film 310 may have an index of refraction that matches, or is substantially same as, that of the light guide 105.

The diffraction grating layer 120 includes diffraction grating elements 220a and the diffraction grating elements 220b. In this example, the diffraction grating layer 120 is a holographic film, which may be a photosensitive material such as dichromate gelatin, a photopolymer, etc. The diffraction grating elements 220a and the diffraction grating elements 220b have been formed in corresponding volumes of the holographic film. Each diffraction grating element may be formed by the interference of a reference beam and an object beam. For example, to produce the diffraction grating elements 220a, the object and reference beams may be collimated beams of light. One beam may strike a photosensitive film in the z direction. The other beam may be propagating in the y direction in a medium (such as a glass medium) that is optically coupled to the film. To produce the diffraction grating elements 220b, one of the two interfering beams may strike the photosensitive film while propagating in free space along the −z axis. The other collimated beam may propagate in the −x direction, in a medium (such as a glass medium) that is optically coupled to the photosensitive film. Suitable photosensitive films in which the diffraction grating elements 220a and the diffraction grating elements 220b may be formed are commercially available from, e.g., Bayer MaterialScience and DuPont.

In alternative implementations, the diffraction grating elements 220a and the diffraction grating elements 220b may be surface relief diffraction grating elements. However, forming the diffraction grating elements 220a and the diffraction grating elements 220b in a holographic film allows a narrower wavelength range to be extracted from, and coupled to, the light guide 105. Moreover, forming the diffraction grating elements in a holographic film allows a narrower angle range of light to be extracted from, and coupled to, the light guide 105.

Some holographic film materials are provided in gel form, or in a similar form. Accordingly, the example shown in FIG. 3 includes support film 310 to provide structural support to the diffraction grating layer 120. Alternative implementations may not include a support film 310.

The light source 210 is capable of edge-coupling light 205 into the light guide 105. As shown in FIG. 3, the light 205 may pass undisturbed through instances of the diffraction grating elements 220b. However, the diffraction grating elements 220a may extract light 205 of a predetermined wavelength range out of the light guide 105. The diffraction grating elements 220a may direct the extracted light 205a out of the light guide 105 within an angle range relative to a plane of the light guide 105. In this example, the extracted light 205a is being directed by a diffraction grating element 220a substantially perpendicular to a plane of the light guide 105, within an angle range of less than 5 degrees. In some implementations, the angle range may be 1 or 2 degrees from a normal to the plane of the light guide 105.

In the example shown in FIG. 3, some of the extracted light 205a is being scattered by the object 305, which is a finger in this example. Some of the incident light 205b may be captured by the diffraction grating elements 220b and directed to corresponding instances of the light sensors 215.

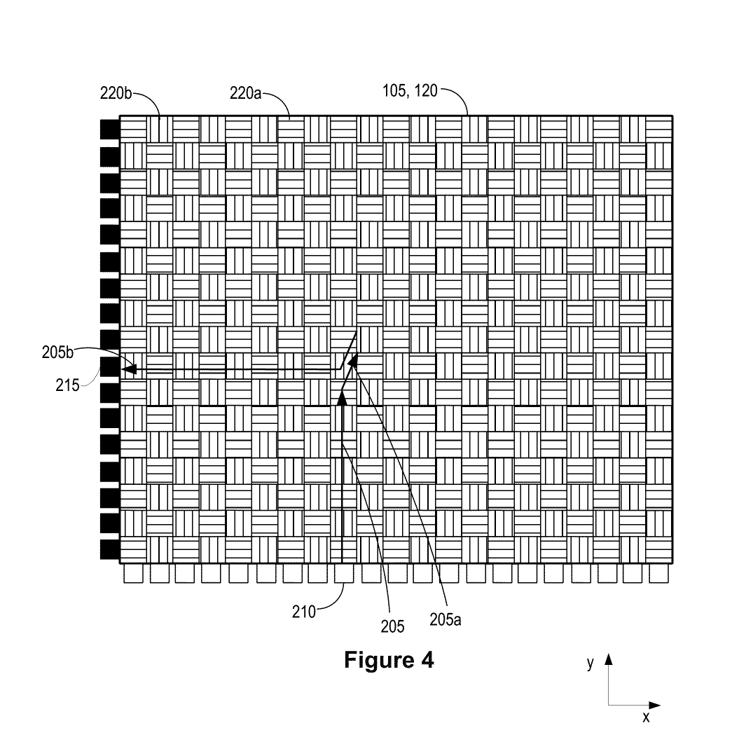

FIG. 4 illustrates another example of a touch/proximity sensing apparatus. In this example, the touch/proximity sensing apparatus 100 includes light sources 210 formed on a first side of the light guide 105 and light sensors 215 formed on a second side of the light guide 105. In this example, the pitch or spacing of the light sources 210 is the same as that of the light sensors 215. In this implementation, each row and column of the diffraction grating layer includes alternating instances of the diffraction grating elements 220a and the diffraction grating elements 220b, laid out in a “checkerboard” pattern. In this example, the diffraction grating elements 220a are the same size as the diffraction grating elements 220b.

During the time depicted in FIG. 4, one of the light sources 210 has provided light 205 to the light guide 105. Some of the light 205 has been extracted by one of the diffraction grating elements 220a. Some of the incident light 205b, which may have been scattered or reflected by an object near the light guide 105, has been directed by a nearby diffraction grating element 220b into the light guide 105 and towards one of the light sensors 215. In the example shown in FIG. 4, the sizes of the diffraction grating elements 220a and 220b correspond with the pitches of the light sources 210 and light sensors 215. However, in alternative implementations the sizes of the diffraction grating elements 220a and 220b may be smaller than the pitches of the light source 210 and the light sensors 215. In such implementations, each grid area (determined by the pitches of the light sources 210 and light sensors 215) includes at least one instance of the diffraction grating elements 220a and at least one instance of the diffraction grating elements 220b. In some implementations, the pitch of the light sources 210 and light sensors 215 may be smaller than the area of a typical finger (for example, smaller than a 10 mm*10 mm area). For example, the pitch of the light sources 210 and light sensors 215 may be in the range of 1 mm to 5 mm. In such configurations, a finger tip may reflect and/or scatter the illumination light from multiple light sources 210 and the reflected/scattered light can be sensed by multiple light sensors 215.

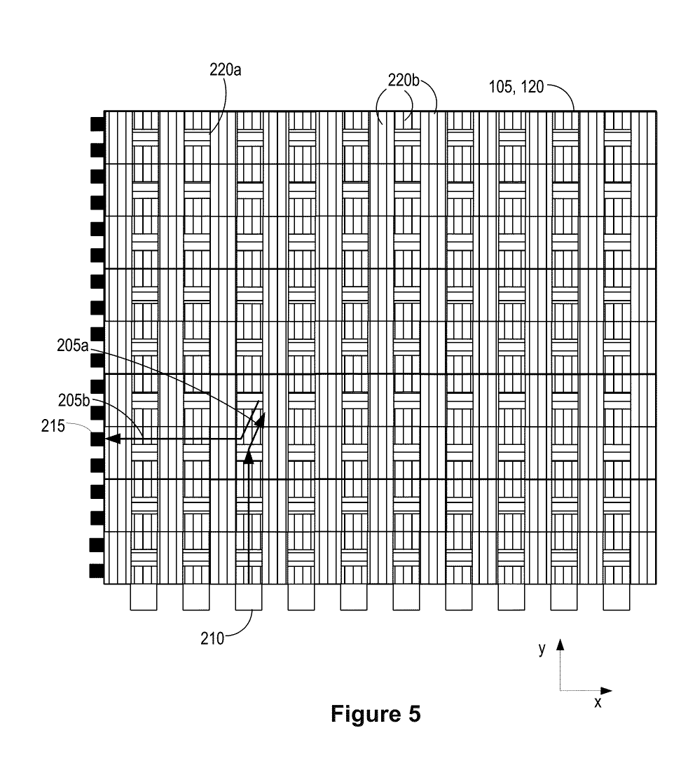

FIG. 5 illustrates an alternative example of a touch/proximity sensing apparatus. In this example, like the example shown in FIG. 4, the touch/proximity sensing apparatus 100 includes light sources 210 formed on a first side of the light guide 105 and light sensors 215 formed on a second side of the light guide 105. However, in the implementation shown in FIG. 5, the pitch of the light sources 210 is not the same as that of the light sensors 215. In this example, the pitch of the light sensors is about half the pitch of the light sources, so that there are twice as many light sensors 215 per unit of length along the y axis as there are light sources 210 per unit of length along the x axis.

In this implementation, the layout of diffraction grating elements 220a and diffraction grating elements 220b corresponds to the difference in pitch between the light sources 210 and light sensors 215. Because there are more sensors 215, more of the diffraction grating layer 120 is devoted to collecting incident light 205b and directing incident light 205b to the light sensors 215. In this example, areas of the diffraction grating elements 220b extend in rows, along the x axis, from each of the light sensors 215. In this implementation, the diffraction grating elements 220a are formed only in portions of the columns, along the y axis, corresponding to each of the light sources 210 and spaces between some of the light sensors 215. Accordingly, in this example the diffraction grating elements 220a are not necessarily the same size as the diffraction grating elements 220b and occupy less of the diffraction grating layer 120. In alternative implementations, the diffraction grating elements 220a may occupy more of the area of the diffraction grating layer 120. For example, in some implementations, the diffraction grating elements 220a may be formed in rows extending from the spaces between all of the light sensors 215.

At the moment shown in FIG. 5, some light 205 from one of the light sources 210 has been extracted by one of the diffraction grating elements 220a. Some of the incident light 205b, which may have been scattered or reflected by an object near the light guide 105, has been directed by a nearby diffraction grating element 220b into the light guide 105 and towards one of the light sensors 215. In this example, the diffraction grating element 220b is located in the same column as the light source 210 and the diffraction grating element 220a.

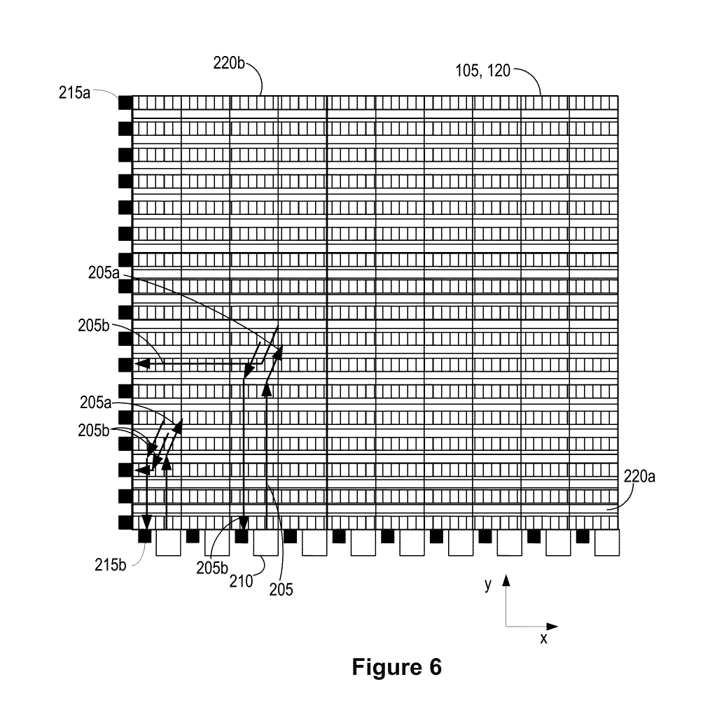

FIG. 6 illustrates another example of a touch/proximity sensing apparatus. In this example, the touch/proximity sensing apparatus 100 includes light sources 210 formed on a first side of the light guide 105 and light sensors 215a formed on a second side of the light guide 105. However, in the implementation shown in FIG. 6, light sensors 215b are formed on the first side of the light guide 105. In this example, the pitch of the light sources 210 on the first side is the same as the pitch of the light sensors 215b on the first side. However, the pitch of the light sensors 215a on the second side is half of the pitch of the light sensors 215b on the first side, such that there are twice as many light sensors 215a per unit length along the y axis as there are light sensors 215b per unit length along the x axis.

The layout of diffraction grating elements 220a and diffraction grating elements 220b corresponds to the arrangement of the light sources 210 and light sensors 215. In this example, each row of diffraction grating elements, along the x axis, has a width, measured along the y axis, that corresponds to the pitch of the light sensors 215a on the second side of the light guide 105. Here, the diffraction grating elements 220b extend in rows, along the x axis, from each of the light sensors 215a. As shown in FIG. 6, the rows of diffraction grating elements 220b may direct incident light 205b to a corresponding light sensor 215a.

In this implementation, the diffraction grating elements 220a extend in rows, along the x axis, from spaces between each of the light sensors 215a on the second side of the light guide 105. The diffraction grating elements 220a are capable of extracting light 205 from the light guide 105. Moreover, the diffraction grating elements 220a are capable of directing incident light 205b to a corresponding light sensor 215b. Accordingly, in this example instances of the diffraction grating elements 220a are capable of diffracting incident light 205b in a first direction within the light guide 105 and instances of the diffraction grating elements 220b are capable of diffracting incident light 205b in a second direction within the light guide 105. In this example, the first direction is substantially orthogonal to the second direction.

In this example, the diffraction grating elements 220a may be substantially the same size as the diffraction grating elements 220b. Here, the diffraction grating elements 220a and the diffraction grating elements 220b each occupy about half of the area of the diffraction grating layer 120.

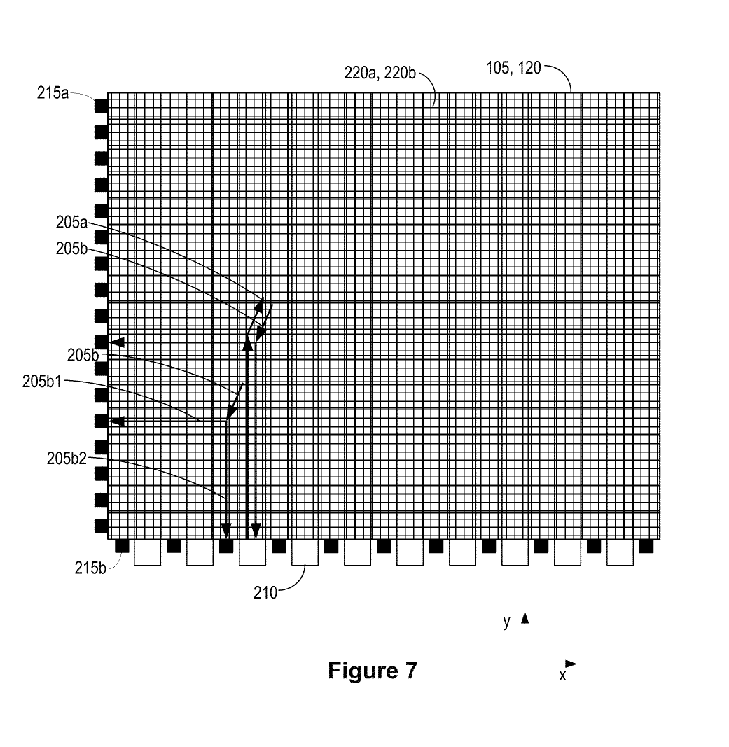

FIG. 7 illustrates another alternative example of a touch/proximity sensing apparatus. In this example, the touch/proximity sensing apparatus 100 includes light sources 210 formed on a first side of the light guide 105 and light sensors 215a formed on a second side of the light guide 105. Like the implementation shown in FIG. 6, light sensors 215b are also formed on the first side of the light guide 105. In this example, the pitches of the light sources 210, the light sensors 215a and the light sensors 215b are all substantially the same as those shown in FIG. 6.

Like the example shown in FIG. 6, in this example instances of the diffraction grating elements 220a are capable of diffracting incident light 205b in a first direction within the light guide 105 and instances of the diffraction grating elements 220b are capable of diffracting incident light 205b in a second direction within the light guide 105. In both examples, the first direction is substantially orthogonal to the second direction.

However, in the implementation shown in FIG. 7, instances of the diffraction grating elements 220a and instances of diffraction grating elements 220b are both located within a single area or volume of the diffraction grating layer 120. Such implementations may be formed, for example, by first exposing each volume of a holographic film to the interference of a reference beam and an object beam suitable for producing the diffraction grating elements 220a, then exposing each volume of the holographic film to the interference of a reference beam and an object beam suitable for producing the diffraction grating elements 220b. As a result, the incident light hitting the area will be simultaneously diffracted into two orthogonal directions, x and y respectively. In each direction, the diffraction efficiency associated with each diffracted beam can be engineered and determined by the holographic exposure process. In some implementations the diffraction efficiency for beams in two directions can be the same but in some other implementations they can be different. By reciprocity, the grating volume will extract the source light 205a from both the x direction and the y direction if light sources 210 are located on both sides of the light guide 105. Such configurations allow two-directional light extraction, and at the same time provide two-directional light collection for both x and y detection. In some more complicated implementations, a volume grating formed by more than two exposures is capable of extracting the source light and redirect the incident light from/to more than two directions. For example, the same volume can extract/redirect light from/to +x, −x and y directions, or +x, −x, +y and −y directions. In some other more complicated implementations, a volume of photosensitive material may be exposed with more than two wavelengths. For example, light with 830 nm and 940 nm wavelengths can be redirected into two different directions by gratings, which may be in a single volume of the holographic film, corresponding to the 830 nm and 940 nm wavelengths. Such implementations may include 2 sets of light sources 210, with one set providing light at a wavelength of approximately 830 nm and the other set providing light at a wavelength of approximately 940 nm.

Accordingly, in this example each volume of the diffraction grating layer 120 includes an instance of the diffraction grating elements 220a and an instance of the diffraction grating elements 220b. Therefore, each volume of the diffraction grating layer 120 is capable of extracting light 205 from the light guide 105. Moreover, each volume of the diffraction grating layer 120 is capable of directing incident light 105b in two directions, indicated as incident light 105b1 and incident light 105b2 in FIG. 7. In this example, the incident light 105b1 is directed to the light sensors 215a and the incident light 105b2 is directed to the light sensors 215b.

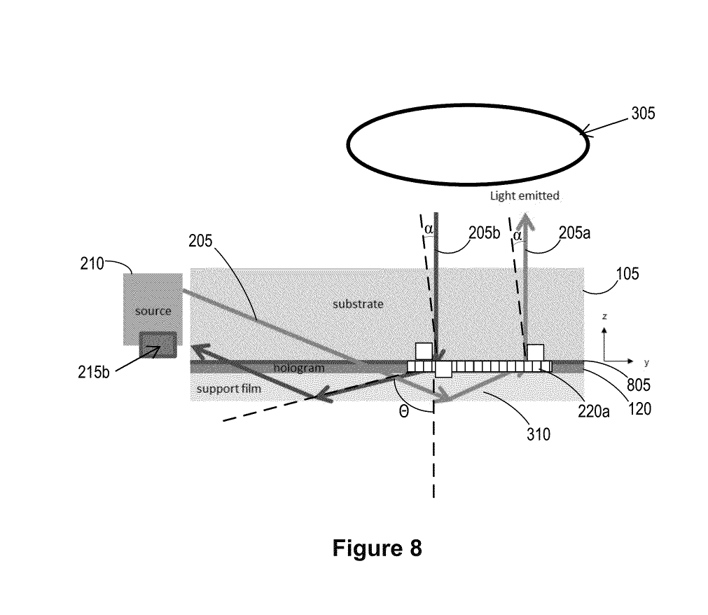

FIG. 8 illustrates a cross-sectional view through a portion of an example of a touch/proximity sensing apparatus. In this example, the touch/proximity sensing apparatus 100 includes light sources 210 and light sensors 215b formed on a first side of the light guide 105. Here, the diffraction grating layer 120 is bonded to the light guide 105 via an adhesive layer 805. A support film 310 provides structural support for the diffraction grating layer 120 in this implementation.

A diffraction grating element 220a is shown within a volume of the diffraction grating layer 120. The diffraction grating element 220a is capable of extracting light 205, within a wavelength range, from the light guide 105 and directing extracted light 205a out of the light guide 105. In this example, the diffraction grating element 220a is capable of directing the extracted light 205a within a predetermined angle range, α, relative to a normal to the plane of the light guide 105.

Some of the extracted light 205a is scattered and/or reflected from an object 305 that is near the light guide 105. Some of the scattered and/or reflected incident light 205b, that is within the wavelength range and the angle range α, is directed by the diffraction grating element 220a into the support film 310 and the light guide 105, towards the sensor 215b. In this implementation, the index of refraction of the support film 310 is approximately the same as that of the light guide 105. In this example, the diffraction grating element 220a is directing the incident light 205b into the light guide 105 at an angle θ relative to a normal to the plane of the light guide 105. In some implementations, the angle θ may be in the range of 45-80 degrees, e.g., approximately 70 degrees.

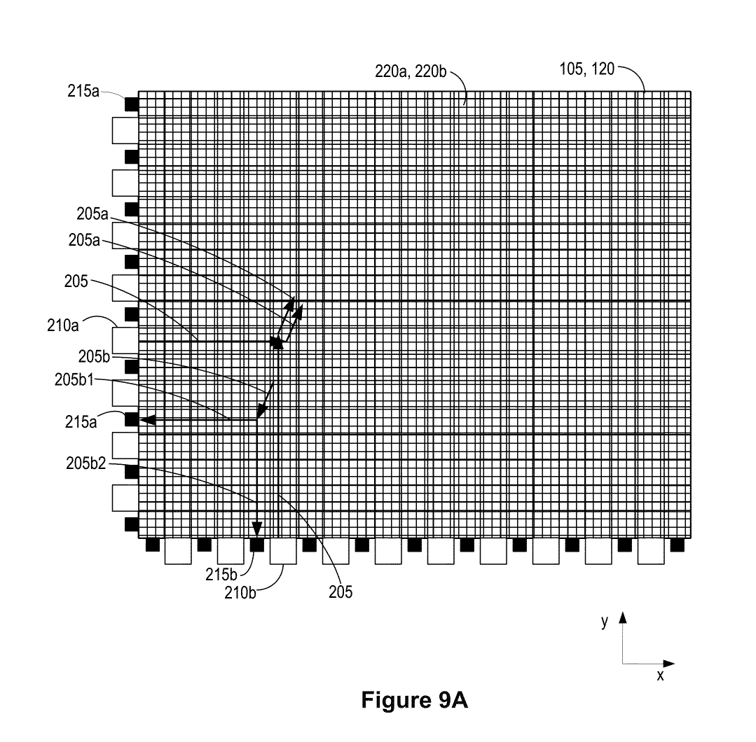

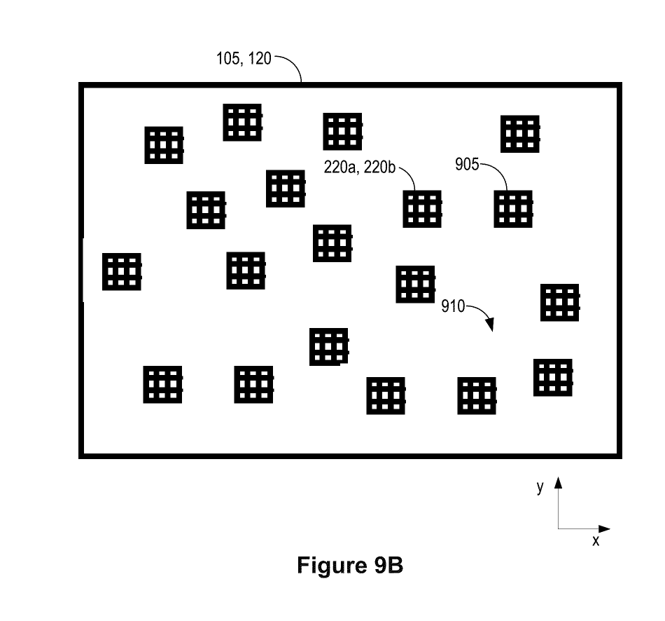

FIG. 9A illustrates an alternative example of a touch/proximity sensing apparatus. In this example, the touch/proximity sensing apparatus 100 includes light sources 210b formed on a first side and light sources 210a formed on a second side of the light guide 105. Light sensors 215a are formed on the second side of the light guide 105 and light sensors 215b are formed on the first side of the light guide 105. In this example, the pitch of the light sources 210a is the same as the pitch of the light sensors 215a. Likewise, the pitch of the light sources 210b is the same as the pitch of the light sensors 215b. In this example, the pitches of the light sources 210a, the light sources 210b, the light sensors 215a and the light sensors 215b are all approximately the same.

Here, each volume of the diffraction grating layer 120 includes an instance of the diffraction grating elements 220a and an instance of the diffraction grating elements 220b. Incident light 205b, that is incident within a wavelength range and within an angle range relative to a plane of the light guide, may be selectively directed, by diffraction grating elements in the same volume of the diffraction grating layer 120, in a first direction and in a second direction within the light guide 105. In FIG. 9, incident light 205b1 is being directed towards one of the light sensors 215a. Incident light 205b2, emanating from the same volume of the diffraction grating layer 120, is being directed towards one of the light sensors 215b.

Due to the principle of reciprocity, the diffraction grating layer 120 may provide corresponding light-extraction functionality. Light 205 that has been provided within a wavelength range and in a first direction (here, along the x axis) by one of the light sources 210a and light 205 that has been provided within the wavelength range and in a second direction (here, along the y axis) by one of the light sources 210b may be extracted, by diffraction grating elements in the same volume of the diffraction grating layer 120, from the light guide 105 as extracted light 205a.

In this example, the diffraction grating elements 220a and the diffraction grating elements 220b extend throughout the diffraction grating layer 120. Having the diffraction grating elements 220a and the diffraction grating elements 220b extend throughout, or at least substantially throughout, the diffraction grating layer 120 allows light within the wavelength range to be directed out of, or into, each corresponding portion of the light guide 105.

FIG. 9B illustrates an example of a diffraction grating layer that provides an alternative arrangement of diffraction grating elements. In the example shown in FIG. 9B, each volume 905 of the diffraction grating layer 120 that includes an instance of the diffraction grating elements 220a and also includes an instance of the diffraction grating elements 220b. In some implementations, the volumes 905 may have an area that is smaller than a pitch of the light sources 210 and/or the light sensors 215 (not shown), whereas in alternative implementations the volumes 905 may have an area that is about the same as the pitch of the light sources 210 and/or the light sensors 215. However, the volumes 905 do not extend throughout the diffraction grating layer 120 in this example. Instead, the volumes 905 are separated from one another by clear areas 910.

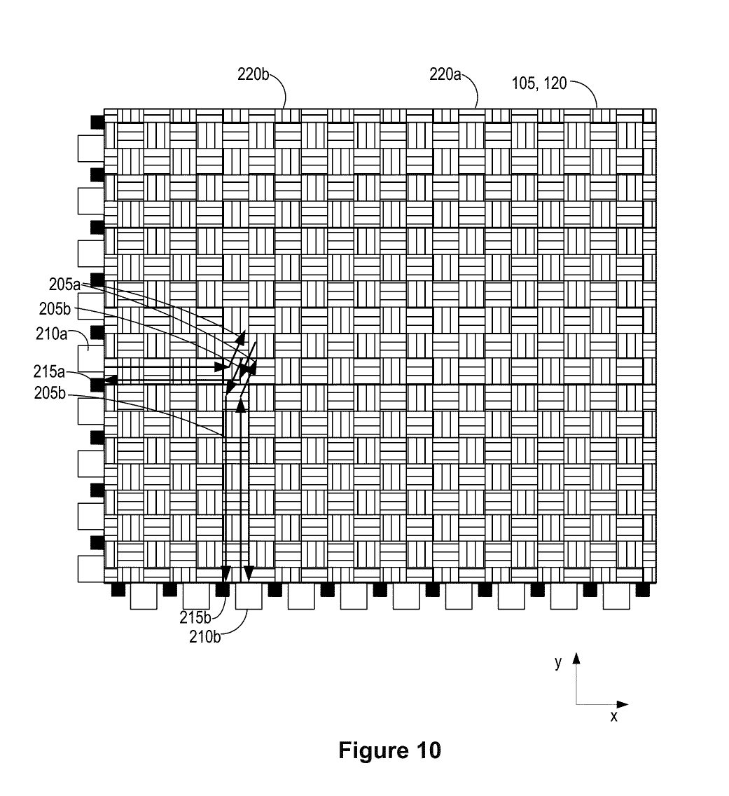

FIG. 10 illustrates another example of a touch/proximity sensing apparatus. In this example, the light sources 210a, the light sources 210b, the light sensors 215a and the light sensors 215b are all arranged as shown in FIG. 9. However, unlike the implementation shown in FIG. 9, each volume of the diffraction grating layer 120 includes either an instance of the diffraction grating elements 220a or an instance of the diffraction grating elements 220b, but not both.

In this example, instances of the diffraction grating elements 220a alternate with instances of the diffraction grating elements 220b, in both x and y directions. Moreover, each row (arranged along the x axis) and column (arranged along the y axis) of diffraction grating elements is offset relative to the light sources and light sensors. In this example, each complete diffraction grating element (but not necessarily those along the edges) partially overlaps at least one of the light sensors and at least one of the light sources. Accordingly, the same diffraction grating element may be capable of extracting light from a light source and providing incident light to a neighboring light sensor.

For example, FIG. 10 illustrates a diffraction grating element 220a that has extracted light provided to the light guide 105 by a light source 210b. The same diffraction grating element 220a has captured incident light 205b and has directed the incident light 205b to a light sensor 215b, adjacent to the light source 210b. FIG. 10 also illustrates a diffraction grating element 220b that has extracted light provided to the light guide 105 by a light source 210a. The same diffraction grating element 220b has captured incident light 205b and has directed the incident light 205b to a light sensor 215a, adjacent to the light source 210a.

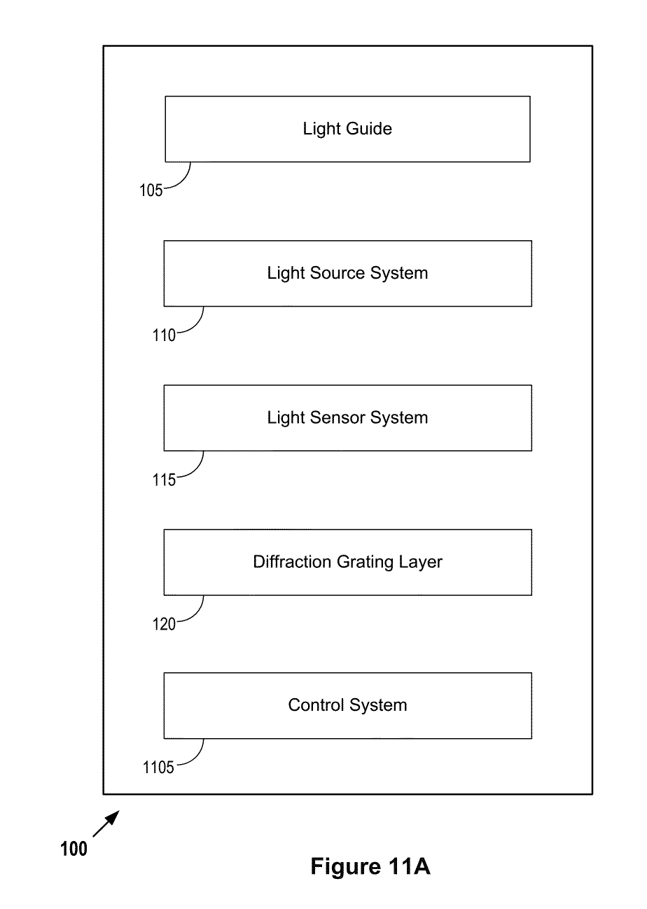

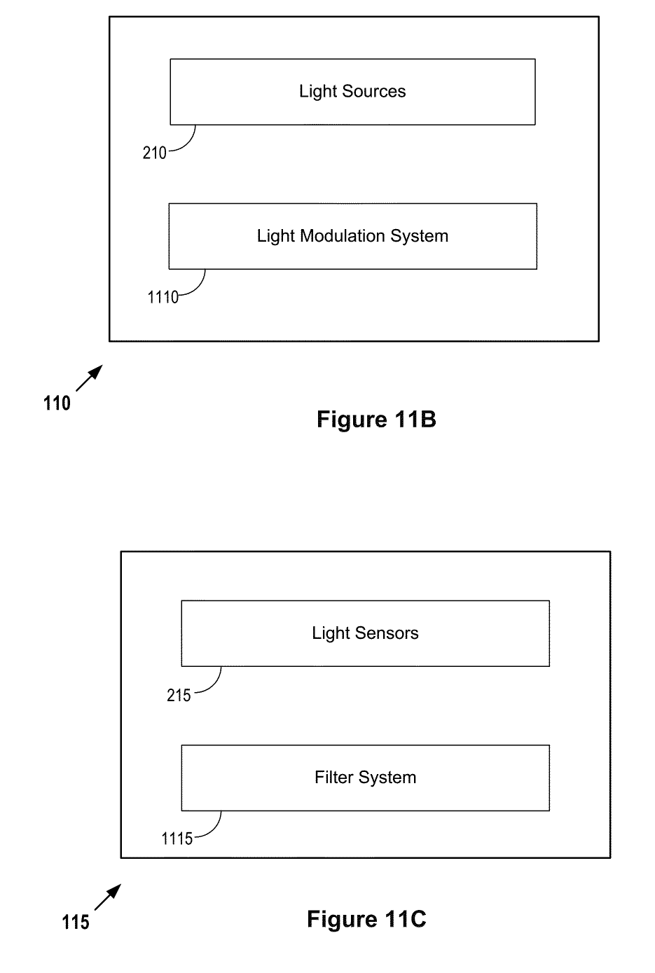

FIG. 11A is a block diagram that shows examples of elements of a touch/proximity sensing apparatus. In this example, the touch/proximity sensing apparatus 100 includes a light guide 105, a light source system 110, a light sensor system 115, a diffraction grating layer 120 and a control system 1105. The light source system 110 may include light sources disposed along, and capable of coupling light of a wavelength range into, at least a first side of the light guide 105. The light sources may be edge-coupled to at least the first side of the light guide 105. The light sensor system 115 may include light sensors disposed along (e.g., edge-coupled to) at least a second side of the light guide 105. In some implementations, at least some light sensors of the light sensor system 115 may be disposed along the first side of the light guide. Moreover, in some examples, at least some light sources of the light source system 110 may be disposed along the second side of the light guide 105.

The diffraction grating layer 120 may be disposed proximate the light guide 105. In some implementations, the diffraction grating layer 120 may be a holographic film layer. The diffraction grating layer 120 may include first diffraction grating elements capable of extracting light of the wavelength range from the light guide 105 and directing extracted light out of the light guide 105. The diffraction grating layer 120 may include second diffraction grating elements capable of directing incident light of the wavelength range into the light guide 105 and towards light sensors of the light sensor system 115. In some implementations, an instance of the first plurality of diffraction grating elements and an instance of the second plurality of diffraction grating elements may both be disposed within a single area or volume of the diffraction grating layer 120. At least some of the incident light may be reflected and/or scattered from an object proximate the light guide 105.

The control system 1105 may, for example, include at least one of a general purpose single- or multi-chip processor, a digital signal processor (DSP), an application specific integrated circuit (ASIC), a field programmable gate array (FPGA) or other programmable logic device, discrete gate or transistor logic, discrete hardware components, or combinations thereof. The control system 1105 may be capable of controlling the operations of the touch/proximity sensing apparatus 100. For example, the control system 1105 may be capable of controlling the light source system 110 and process light sensor data from the light sensor system 115 according to software stored in a non-transitory medium.

In some implementations, the control system 1105 may be capable of controlling the light source system 110 to provide light to at least the first side of the light guide 105. For example, the control system 1105 may be capable of causing the light sources to provide light to the light guide 105 in a sequential manner. In some implementations, the control system 1105 may be capable of causing substantially all of the light sources disposed on the first side (and/or the second side) of the light guide 105 to provide light at substantially the same time. In some implementations, the control system 1105 may be capable of causing individual light sources on the first side to provide light in a certain pattern. For example, the control system 1105 may be capable of causing the 1^{st} and the 3^{rd} light sources to light up during a first time frame, of causing the 2^{nd} and 4^{th} light sources to light up during a second time frame and so on. In some implementations, the control system 1105 may be capable of causing individual light sources to provide light in different intensities in order to compensate for the non-uniform light-turning efficiency of the diffraction grating elements 220b from the columns near the sensor and the columns further away from the sensor.

The control system may be capable of causing the light source system 110 to provide modulated light to the light guide 105. FIG. 11B is a block diagram that shows example components of a light source system. In this example, the light source system 110 includes light sources 210, which may be as described above. In this example, the light source system 110 also includes a light modulation system 1110. Conceptually, the light modulation system 1110 also may be considered a component of the control system 1105. The light modulation system 1110 may be capable of modulating the wavelength and/or amplitude of light provided by the light sources 210.

In some implementations, the control system may include a filter capable of passing modulated incident light of the wavelength range to light sensors of the light sensor system 115. FIG. 11C is a block diagram that shows example components of a light sensor system. In this example, the light sensor system 115 includes light sensors 215 and a filter system 1115. The filter system 1115 also may be regarded as a component of the control system 1105. The filter system 1115 may be capable of filtering out light that is not within a predetermined wavelength range and of passing light to the light sensors that are within the wavelength range. If wavelength-modulated light is being provided by the light source system 110, the passed wavelength range may include a corresponding range of wavelength modulation.

The control system 1105 may be capable of receiving light sensor data from the light sensor system 115. The light sensor data may correspond to incident light received by light sensors of the light sensor system 115. The control system 1105 may be capable of determining a location of an object from which the incident light was scattered or reflected based, at least in part, on the light sensor data.

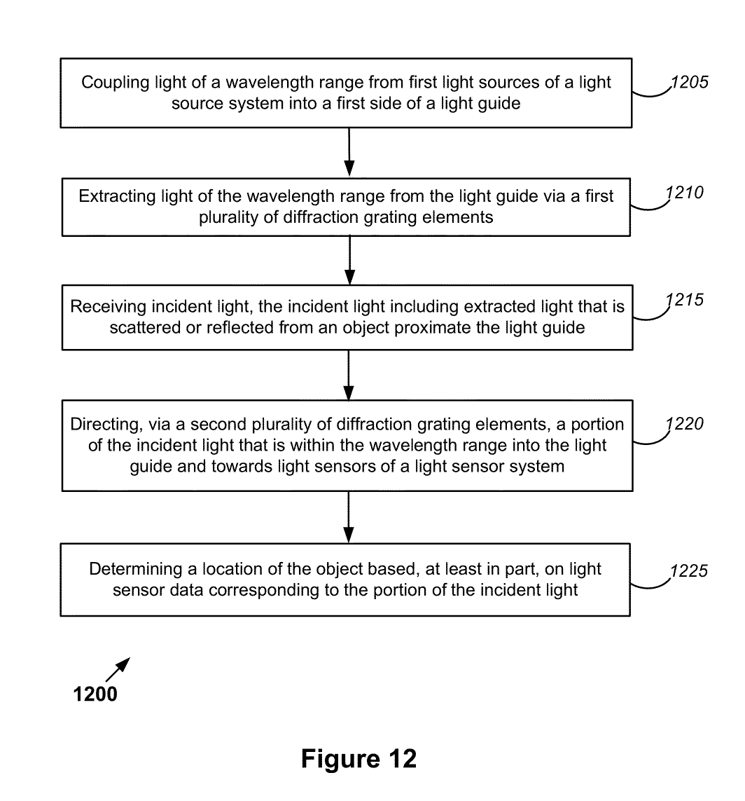

FIG. 12 is a flow diagram that outlines blocks of a method of controlling a touch/proximity sensing apparatus. In this example, the method 1200 begins with block 1205, which involves coupling light of a wavelength range from first light sources of a light source system into at least a first side of a light guide. In some implementations, block 1205 may involve controlling the light sources to provide light in a sequential manner. However, in some examples block 1205 may involve controlling the first light sources to provide light at substantially the same time. Alternatively, or additionally, block 1205 may involve controlling second light sources to provide light to the second side of the light guide at substantially the same time. In some implementations, block 1205 may involve coupling modulated light of the wavelength range into at least the first side of the light guide.

Here, block 1210 involves extracting light of the wavelength range from the light guide. In this example, block 1210 involves extracting light of the wavelength range via at least a first plurality of diffraction grating elements.

In this example, block 1215 involves receiving incident light. The incident light may include extracted light that is scattered or reflected from an object proximate the light guide. Here, block 1220 involves directing, via (at least) a second plurality of diffraction grating elements, a portion of the incident light that is within the wavelength range into the light guide and towards light sensors of a light sensor system. In some implementations, block 1220 may involve directing incident light of the wavelength range towards light sensors disposed on a second side of the light guide. Alternatively, or additionally, block 1220 may involve directing incident light of the wavelength range towards light sensors disposed on the first side of the light guide.

In some implementations, blocks 1210 and 1220 may be performed, in part, by diffraction grating elements in a single area or volume of a diffraction grating layer. For example, blocks 1210 and 1220 may be performed, in part, by a single instance of the first plurality of diffraction grating elements and a single instance of the second plurality of diffraction grating elements, both instances being in the same area or volume of a diffraction grating layer.

In some implementations, method 1200 may include a process of filtering the incident light to pass light within the wavelength range to the light sensors. The process may involve filtering the incident light to pass modulated light within the wavelength range to the light sensors. In this implementation, block 1225 involves determining a location of the object based, at least in part, on light sensor data corresponding to the portion of the incident light that is scattered or reflected from the object.

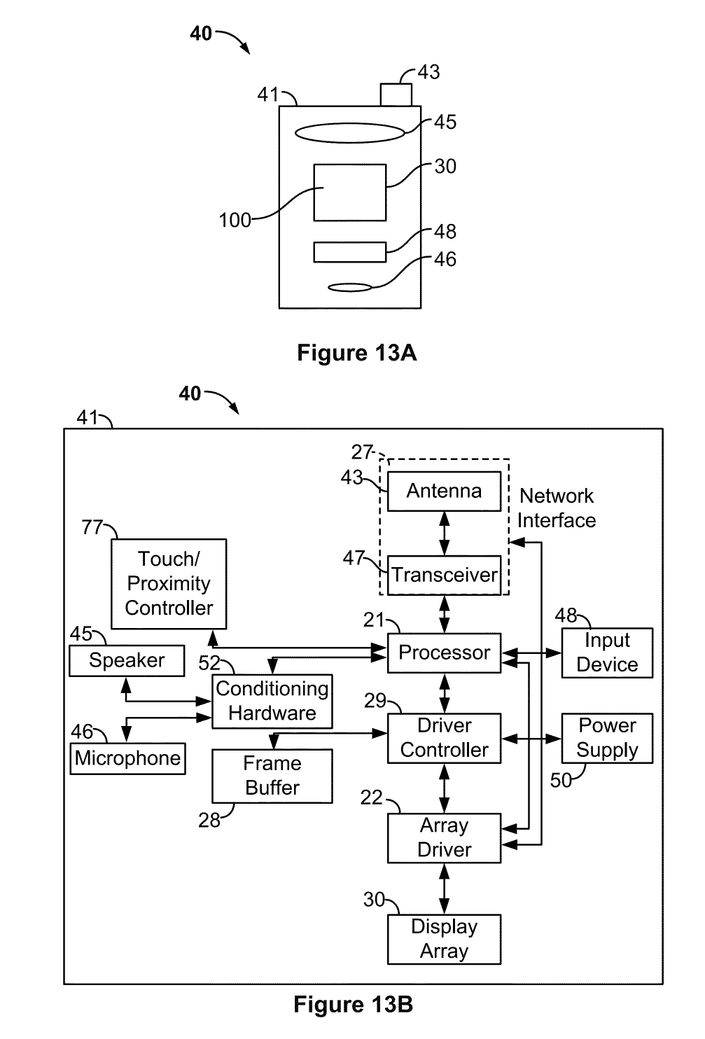

FIGS. 13A and 13B show examples of system block diagrams illustrating a display device that includes a touch/proximity sensing apparatus as described herein. The display device 40 can be, for example, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, a touch/proximity sensing apparatus 100, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can include a flat-panel display, such as plasma, EL, OLED, STN LCD, or TFT LCD, or a non-flat-panel display, such as a CRT or other tube device. In addition, the display 30 can include an IMOD-based display, as described herein. In this example, touch/proximity sensing apparatus 100 overlies the display 30.

The components of the display device 40 are schematically illustrated in FIG. 10B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be capable of conditioning a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 10B, can be capable of functioning as a memory device and be capable of communicating with the processor 21. In some implementations, a power supply 50 can provide power to substantially all components in the particular display device 40 design.

In this example, the display device 40 also includes a touch/proximity controller 77. The touch/proximity controller 77 may be capable of communicating with the touch/proximity sensing apparatus 100, e.g., via routing wires, and may be capable of controlling the touch/proximity sensing apparatus 100. The touch/proximity controller 77 may be capable of determining a touch location of a finger, a stylus, etc., proximate the touch/proximity sensing apparatus 100. The touch/proximity controller 77 may be capable of making such determinations based, at least in part, on detected changes in voltage and/or resistance in the vicinity of the touch or proximity location. In alternative implementations, however, the processor 21 (or another such device) may be capable of providing some or all of this functionality. Accordingly, a control system 1105 as described elsewhere herein may include the touch/proximity controller 77, the processor 21 and/or another element of the display device 40.

The touch/proximity controller 77 (and/or another element of the control system 120) may be capable of providing input for controlling the display device 40 according to the touch location. In some implementations, the touch/proximity controller 77 may be capable of determining movements of the touch location and of providing input for controlling the display device 40 according to the movements. Alternatively, or additionally, the touch/proximity controller 77 may be capable of determining locations and/or movements of objects that are proximate the display device 40. Accordingly, the touch/proximity controller 77 may be capable of detecting finger or stylus movements, hand gestures, etc., even if no contact is made with the display device 40. The touch/proximity controller 77 may be capable of providing input for controlling the display device 40 according to such detected movements and/or gestures.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be capable of allowing, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be capable of functioning as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be capable of receiving power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus. above-described optimization

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that can be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD (or any other device) as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
a light guide;
a light source system including a first plurality of light sources capable of coupling light into a first side of the light guide;
a light sensor system including a plurality of light sensors edge-coupled to at least a second side of the light guide; and
a diffraction grating layer proximate the light guide, the diffraction grating layer including:
a first plurality of diffraction grating elements capable of extracting light from the light guide and directing extracted light out of the light guide; and
a second plurality of diffraction grating elements capable of directing incident light into the light guide and towards the plurality of light sensors.

2. The apparatus of claim 1, wherein an instance of the first plurality of diffraction grating elements and an instance of the second plurality of diffraction grating elements are both within a single area or volume of the diffraction grating layer.

3. The apparatus of claim 1, wherein the diffraction grating layer is a holographic film layer.

4. The apparatus of claim 1, wherein at least some instances of the first plurality of diffraction grating elements are capable of selectively directing extracted light within a wavelength range and within a first angle range relative to a plane of the light guide.

5. The apparatus of claim 1, wherein the second plurality of diffraction grating elements is capable of selectively directing light that is incident within a wavelength range and within an angle range, relative to a plane of the light guide, towards the plurality of light sensors.

6. The apparatus of claim 1, wherein at least some light sensors of the light sensor system are disposed on the first side of the light guide and wherein at least some instances of the first plurality of diffraction grating elements are capable of directing light towards a corresponding light sensor disposed on the first side of the light guide.

7. The apparatus of claim 1, wherein instances of the first plurality of diffraction grating elements are capable of diffracting incident light in a first direction within the light guide and instances of the second plurality of diffraction grating elements are capable of diffracting incident light in a second direction within the light guide.

8. The apparatus of claim 7, wherein the first direction is substantially orthogonal to the second direction.

9. The apparatus of claim 1, wherein the light source system is capable of providing modulated light of a wavelength range into the light guide.

10. The apparatus of claim 9, wherein the apparatus includes a filter capable of passing the modulated incident light of the wavelength range to the light sensors.

11. The apparatus of claim 1, wherein the light source system includes at least one vertical-cavity surface-emitting laser (VCSEL).

12. The apparatus of claim 1, wherein at least some of the incident light is reflected or scattered from an object, further comprising a control system capable of:
controlling the light source system to provide light to at least the first side of the light guide;
receiving light sensor data from the light sensor system, the light sensor data corresponding to incident light received by light sensors; and
determining a location of the object based, at least in part, on the light sensor data.

13. The apparatus of claim 1, wherein at least some light sensors of the light sensor system are edge-coupled to the first side of the light guide.

14. The apparatus of claim 13, wherein the light source system includes a second plurality of light sources disposed on, and capable of coupling light into, the second side of the light guide.

15. The apparatus of claim 14, wherein at least some of the incident light is reflected or scattered from an object, further comprising a control system capable of:
causing the first plurality of light sources or the second plurality of light sources to provide light at substantially the same time;
receiving light sensor data from the light sensor system, the light sensor data corresponding to incident light received by light sensors; and
determining a location of the object based, at least in part, on the light sensor data.

16. An apparatus, comprising:
means for guiding light;
means for coupling light into a first side of the light guide means;
means for sensing light from a second side of the light guide means;
means for extracting light from the light guide means and for directing extracted light out of the light guide means; and
means for directing incident light into the light guide means and towards the light sensing means.

17. The apparatus of claim 16, wherein an instance of the extracting means and an instance of the directing means are both within a single area or volume of a diffraction grating layer proximate the light guide means.

18. The apparatus of claim 17, wherein the diffraction grating layer is a holographic film layer.

19. The apparatus of claim 16, wherein at least some instances of the light sensing means are disposed on the first side of the light guide means and wherein at least some instances of the light-extracting means include means for directing light towards a corresponding instance of the light sensing means disposed on the first side of the light guide means.

20. The apparatus of claim 16, wherein instances of the light-extracting means include means for diffracting incident light in a first direction within the light guide means, wherein instances of the light-directing means include means for diffracting incident light in a second direction within the light guide means, and wherein the first direction is substantially orthogonal to the second direction.

21. A non-transitory medium having software stored thereon, the software including instructions for controlling at least one device to:
couple light of a wavelength range from first light sources of a light source system into a first side of a light guide, the light guide including a first plurality of diffraction grating elements capable of extracting light of the wavelength range from the light guide, the light guide being capable of:
receiving incident light, including extracted light that is scattered or reflected from an object proximate the light guide; and
directing, via a second plurality of diffraction grating elements, a portion of the incident light that is within the wavelength range into the light guide and towards light sensors of a light sensor system; and
determine a location of the object based, at least in part, on light sensor data corresponding to the portion of the incident light.

22. The non-transitory medium of claim 21, wherein the directing involves directing incident light towards light sensors disposed on the first side of the light guide, wherein the software includes instructions for controlling the first light sources to provide light at substantially the same time.

23. The non-transitory medium of claim 21, wherein the directing involves directing incident light towards light sensors disposed on the first side of the light guide, wherein the software includes instructions for controlling second light sources to provide light to the second side of the light guide at substantially the same time.

24. A method, comprising:
coupling light of a wavelength range from first light sources of a light source system into a first side of a light guide;
extracting light of the wavelength range from the light guide via a first plurality of diffraction grating elements;
receiving incident light, the incident light including extracted light that is scattered or reflected from an object proximate the light guide;
directing, via a second plurality of diffraction grating elements, a portion of the incident light that is within the wavelength range into the light guide and towards light sensors of a light sensor system; and
determining a location of the object based, at least in part, on light sensor data corresponding to the portion of the incident light.

25. The method of claim 24, wherein the directing involves directing incident light towards light sensors disposed on a second side of the light guide.

26. The method of claim 25, wherein the directing involves directing incident light towards light sensors disposed on the first side of the light guide.

27. The method of claim 26, further comprising controlling the first light sources to provide light at substantially the same time.

28. The method of claim 26, further comprising controlling second light sources to provide light to the second side of the light guide at substantially the same time.

29. The method of claim 24, wherein the extracting and the directing are performed, at least in part, by an instance of the first plurality of diffraction grating elements and an instance of the second plurality of diffraction grating elements, both instances being in a single area or volume of a diffraction grating layer.

30. The method of claim 24, wherein the coupling involves coupling modulated light of the wavelength range into the first side of the light guide, further comprising filtering the incident light to pass modulated light within the wavelength range to the light sensors.
